(19) United States
(12) Patent Application Publication
(10) Pub. No.: US 2015/0074350 A1
(43) Pub. Date: Mar. 12, 2015

(54) MEMOIZATION BUCKETS FOR CACHED FUNCTION RESULTS

(71) Applicants: Frank Feng-Chun Chiang, Brighton, MA (US); Ashkan Nasseri, Somerville, MA (US)

(72) Inventors: Frank Feng-Chun Chiang, Brighton, MA (US); Ashkan Nasseri, Somerville, MA (US)

(21) Appl. No.: 14/019,734

(22) Filed: Sep. 6, 2013

(51) Int. Cl. G06F 12/08

(52) U.S. Cl. CPC G06F 12/0802
USPC 711/118

(57) ABSTRACT

A memoization system and method arranges cached function results into groups, or buckets, to identify related cache values to invalidate upon obsolescence (staleness) of any one of the cached values in the group. A wrapper function in coded invocations to the cached functions identifies a group to which the function result belongs. Values in a cache group are denoted as a bucket, and subsequent functions that render the cached values obsolete are also invoked via a wrapper function indicating the bucket. The invalidate wrapper results in invalidation of all of the obsolete values in the bucket such that subsequent invocations will not attempt to employ the outdated values.

### BACKGROUND

In a server computing environment, servers are responsive to remote computing devices for focusing and consolidating services that are computationally or data intensive, to allow relatively lightweight computing appliances to leverage the power of the more robust server functionality. For example, a remote computing device such as a smartphone, tablet or laptop may have limited database resources. However, a network or wireless link to a database server can respond to requests from the database which would be infeasible for the remote computing device to support alone, due to the size of the database.

Accordingly, many computing environments equip lightweight and/or portable computing appliances (laptops, smartphones, PDAs and other personal computing devices) with applications (apps) for establishing a connection or link to a server for fulfilling computation requests that the lightweight appliance could not support on its own. For example, in some contexts, an enterprise management application provides networking, collaboration, and configuration support for a plurality of individual computing devices having a common purpose, motivation or direction, such as a particular business, organization or project. The enterprise management application coordinates application installation and oversees operation of the apps executing on each of the computing devices. The enterprise management application also facilitates access to a set of support servers for providing various services. Such services are likely to include data management, computation and retrieval services, and are further likely to be called upon for similar or related requests due to the common orientation of the enterprise. In other words, many users are likely to be invoking (requesting) the same or similar functions due to shared or common business goals.

### SUMMARY

A memoization system and method arranges cached function results into groups, or buckets, to identify related cache values to invalidate upon obsolescence (staleness) of any one of the cached values in the group. A wrapper function in coded invocations to the cached functions identifies a group to which the function result belongs. Values in a cache group are denoted as one or more buckets, and subsequent functions that render the cached values obsolete are also invoked via a wrapper function indicating the group. The invalidate wrapper results in invalidation of all of the obsolete values in the bucket such that subsequent invocations will not attempt to employ the outdated values. Memoization, as employed herein, refers to caching results of function calls to avoid repeating the calculation of results for duplicate parameters of previously processed inputs, and more generally can refer to any value that might be requested in the future, whether computationally, database, or I/O (input/output) intensive.

Configurations herein are based, in part, on the observation that caches are frequent used for recurrently retrieved or computed values, such as database fetches and computational results. A function request (invocation) is first met with a cache scan to identify a cache “hit” or “miss.” In the case of a cache hit, the requested result need not be recomputed or fetched, but is instead merely retrieved from the cache. Naturally, therefore, the cache is usually a high speed memory area that is faster than the corresponding I/O fetch or computation would have taken.

Cache values, however, become obsolete when one or more of the factors in the cached result changes. This may be due to a database update or software modification of state information (i.e. variables) employed in generating the requested function result. Cached values need to be invalidated when any of the factors affecting the result changes. Unfortunately, conventional approaches to caching function values suffer from the shortcoming that it can be problematic to identify and invalidate stale cache values so that subsequent access attempts invoke the function anew rather than accepting obsolete values. For example, a function to retrieve available applications needs to be updated when a new application is installed. Therefore, operations that modify the set of applications need to invalidate cached results so that subsequent requests seek fresh data. Similarly, operations requesting information on applications need to indicate that they are relying on the applications data for reliability.

Accordingly, configurations herein substantially overcome the shortcomings of conventional cached value retrieval by identifying buckets of cache entries, and invalidating the buckets from functions which modify or render the cached data obsolete. A wrapper function (command) identifies the bucket for functions that attempt to be satisfied by reading cached values, and an invalidate wrapper function (command) accompanies functions that modify (directly or indirectly) the cached data in the bucket, so that stale data is not propagated.

Identification of the bucket is provided by a label from a wrapper function or other command that accompanies the request. One mechanism encapsulates the coded invocation of the function invocation request, however other mechanisms may be employed for labeling a cacheable value as belonging to a bucket. Similarly, the invalidate command may emanate from a wrapper function encapsulating a function that writes changes affecting the cached values in the bucket, so that any potential change to the cached values in the bucket will be denoted and indicate the need to refresh the cached values.

In further detail, in the managed application environment, an app employs the disclosed cache buckets and disclosed method of caching computational results by issuing a cache grouping command in conjunction with an invocation of function resulting in a cached function result, and associating the cached function result with the cache group. Subsequently, a potentially compromising function causes issuance of an invalidate command indicative of the cache group, and invalidates all cached function results in the cache group.

The server, upon receiving the request, performs the disclosed method of caching computed values by identifying a cached entity, in which the cached entity was generated by execution of a function, and labeling the cached entity with a group indicative of a plurality of related cached entities. Subsequently, the server receives a request to invalidate at least one cached entity in the labeled group, and invalidates the cached entity and each related cached entity in the labeled group.

Alternate configurations of the invention include a multiprogramming or multiprocessing computerized device such as a multiprocessor, controller or dedicated computing device or the like configured with software and/or circuitry (e.g., a processor as summarized above) to process any or all of the method operations disclosed herein as embodiments of the invention. Still other embodiments of the invention include software programs such as a Java Virtual Machine and/or an operating system that can operate alone or in conjunction with each other with a multiprocessing computerized device to perform the method embodiment steps and operations summarized above and disclosed in detail below. One such embodiment comprises a computer program product that has a non-transitory computer-readable storage medium including computer program logic encoded as instructions thereon that, when performed in a multiprocessing computerized device having a coupling of a memory and a processor, programs the processor to perform the operations disclosed herein as embodiments of the invention to carry out data access requests. Such arrangements of the invention are typically provided as software, code and/or other data (e.g., data structures) arranged or encoded on a computer readable medium such as an optical medium (e.g., CD-ROM), floppy or hard disk or other medium such as firmware or microcode in one or more ROM, RAM or PROM chips, field programmable gate arrays (FPGAs) or as an Application Specific Integrated Circuit (ASIC). The software or firmware or other such configurations can be installed onto the computerized device (e.g., during operating system execution or during environment installation) to cause the computerized device to perform the techniques explained herein as embodiments of the invention.

### BRIEF DESCRIPTION OF THE DRAWINGS

The foregoing and other objects, features and advantages of the invention will be apparent from the following description of particular embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a context diagram of a server computing environment suitable for use with configurations herein;

FIG. 2 is a flowchart of a server using memoization buckets in the server computing environment of FIG. 1;

FIG. 3 is a block diagram of memoization bucket usage as in FIG. 2;

FIG. 4 shows a hierarchy of the buckets of FIG. 3;

FIG. 5 shows grouping of buckets defined by the hierarchy of FIG. 4;

FIG. 6 shows a flowchart of caching in the buckets of FIG. 3; and

FIG. 7 shows a flowchart of cache invalidation of the buckets in FIG. 6.

### DETAILED DESCRIPTION

Depicted below is an example configuration of a managed application environment depicting an example configuration for caching computed results according to the memoization method disclosed herein. Other configurations may employ the same or similar operations without departing from the ideas embodied herein. In the examples below, a web server, upon receiving the request, performs the disclosed method of caching computed values by identifying a cached entity, in which the cached entity was generated by execution of a function, and labeling the cached entity with a group indicative of a plurality of related cached entities. Subsequently, the server receives a request to invalidate at least one cached entity in the labeled group, and invalidates the cached entity and each related cached entity in the labeled group.

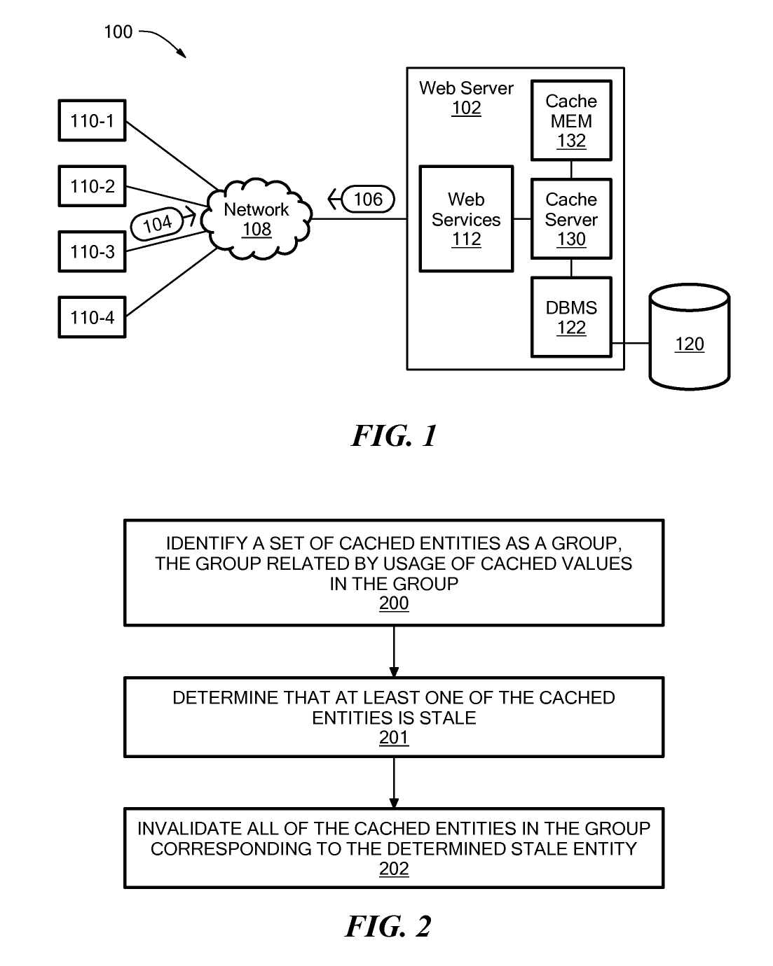

FIG. 1 is a context diagram of a server computing environment 100 suitable for use with configurations herein. Referring to FIG. 1, in the server computing environment 100, a server 102 provides computing services to plurality of computing devices 110-1 . . . 110-4 (110 generally) via a network 108. The network 108 is a wired or wireless interconnection medium, such as the Internet, corporate intranet, and any combination of LANs or WANs (Local/Wide Area Networks). The computing devices 110 may be any suitable processing device, such as smartphones, laptops, tablets and other portable and desktop computing devices. In a particular configuration, the computing devices 110 may be iPad® devices responsive to an enterprise management application.

The server 102 includes a web services module 112 for receiving requests 104 for computing services and providing responses 106. The web services module 112 is a computing process or executable entity operable to provide the response 106. In conjunction with computing the response 106, a cache server 130 invokes a database (DB) manager 122 or cache memory 132. The cache server 130 determines if a request 104 can be fulfilled from previously computed or fetched values in the cache memory 132, or whether DB accesses need be incurred from the DB 120 to satisfy the request 104. The response 106 is then sent to the requesting computing device 110 using the cached or fetched values.

FIG. 2 is a flowchart of a server using memoization buckets in the server computing environment of FIG. 1. Referring to FIGS. 1 and 2, the method of caching computational results as disclosed herein includes, at step 200, identifying a set of cached entities as a group, in which the group is related by usage of cached values in the group. The group, which may include one or more buckets of cached values, shares a common type, usage or focal point such that invalidation (usually obsolescence of the computed value) of one of the values affects the validity of the other values in the group. A subsequent function call determines that at least one of the cached entities is stale, as depicted at step 201, and invalidates all of the cached entities in the group corresponding to the determined stale entity, as shown at step 202. Invalidation of the related cached entities ensures that subsequent attempts to access the cached values do not return stale or obsolete cached data, as when applications omit a command or call to invalidate previously cached values.

Configurations herein depict a method of when and how to invalidate the cache. One aspect of using memoization is that it is difficult to know whether the value in the database has changed. In conventional approaches, a developer is responsible for invalidating the cache when the database values are changed, but this approach is often error-prone. Because of this, the common solution is simply to set a cache expiration timeout, so that if the developer forgot to invalidate the cache, the stale result would only persist until the cache key expires. The less confident a developer is, the lower the expiration value. Timeouts, however, are subjective and it can be difficult to identify a fixed time for which the value remains valid. A longer timeout risks propagation of stale values, and a shorter timeout may unnecessarily recompute a value when the cached value was still valid.

For example, take two functions: get_applications( ) and edit_application(application). A caching mechanism can cache the result of get_applications( ), which returns a list of applications. However, if edit_application( ) is called, it would cause the cached result to be stale. Because of this, the developer needs to invalidate/delete the cached value generated by get_applications( ) when edit_application( ) is called. Because of the sheer number of data-layer functions, it is very difficult to know whether all cache keys are correctly invalidated in all situations.

Configurations herein employ memoization buckets to facilitate the invalidation of the cache keys. When defining get_applications( ) and edit_application( ), both functions are defined as being in the “applications” bucket. Each function would then either have the “cache” action or “invalidate” action, which specifies whether the function should cache the return value or delete the cache keys in the bucket respectively. In this case, get_applications( ) would be a “cache” action, while edit_application( ) would be “invalidate”. This example is shown further below in table 1. Functions employing cacheable results generally operate in complementary arrangements foe caching and invalidation. The buckets help to simplify caching/invalidation of cache keys. The invalidation command can also keep track of the cache keys that were deleted and re-generate them automatically.

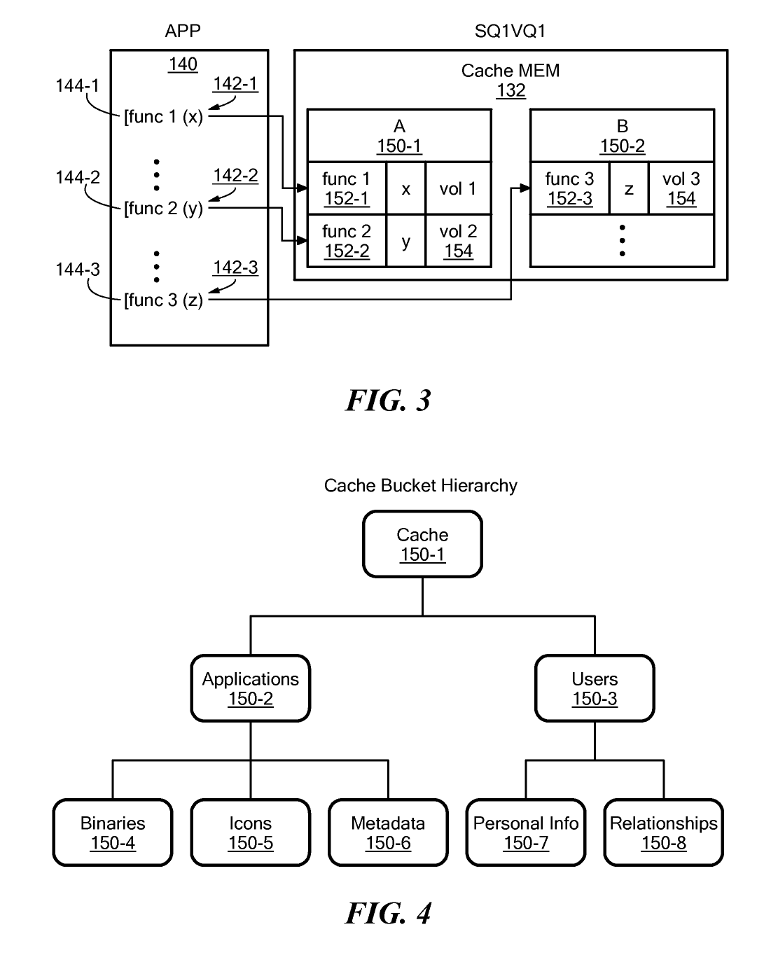

FIG. 3 is a block diagram of memoization bucket usage as in FIG. 2. Referring to FIGS. 1-3, in the server computing environment 100, applications (apps) 140 make function calls 142-1 . . . 142-3 (142 generally) that trigger a cache access. The function call 142 also indicates the bucket, such as via a wrapper function 144-2 . . . 144-3 (144, generally). The wrapper function 144 may be a code item specifying the bucket, however any suitable mechanism may issue the bucket specification and command. In the example configuration, the cache grouping command is a wrapper function encapsulating the invoked function, and performs the caching operation in conjunction with executing the invoked function if the value is not found in the cache (i.e. a cache “miss”).

The corresponding invalidate command may also be a wrapper function encapsulating a function potentially rendering the cached function results in the cache group obsolete. The invalidate command also identifies complementary functions in the group, in which the complementary functions are for associating cached values with the group and invalidating the associated cached entities storing the cached values in the group. The group is defined by at least one bucket, which identifies the set of functions having cache values that are invalidated together.

The wrapper function designates the bucket 150-1 . . . 150-2 (150 generally), defined as an area of cache memory 132 for storing the related cache entries 152-1 . . . 152-3. Each cache entry 152 stores a cache value 154, which is indexed or references by the function name and arguments, typically via a hash value. In the example shown, calls to func1(x) and func2(x) specify bucket A, and a call to func3(z) specifies bucket B. Cache memory 132 indexes the cache values 144 by the function name and arguments in the corresponding buckets 150. Bucket 150 storage is shown as an example, and the bucket 150 may be implemented in any suitable manner to group the entries 152 stored thereby. It need not be a contiguous memory area and may be suitable indexed as appropriate. Corresponding wrapper functions writing to cache values 154 in the bucket 150 result in invalidation of all values 154 in the bucket 150.

FIG. 4 shows a hierarchy of the buckets of FIG. 3. Referring to FIGS. 3 and 4, cache dependencies define indirect, or “ripple” effects resulting when values in one bucket affect values in another bucket. A hierarchy 160 includes buckets 150-1 . . . 150-8, and indicates which buckets draw or compute based on values in other buckets 150, and hence those which are also rendered invalid when the subordinate bucket is invalidated. Invalidation proceeds up the tree towards the root node 150-1. Therefore, buckets 150 on lower levels do not need to be invalidated when buckets on higher levels are modified, or invalidated. For example, the applications bucket 150-2 depends on values drawn from the icons bucket 150-5. Hence, a change/invalidation to the icons bucket 150-5 triggers an invalidation to the applications bucket, since the icons used by the applications need to incorporate those changes. The binaries bucket 150-4 and the metadata bucket 150-6 need not change merely due to an invalidation of the icons bucket 150-5.

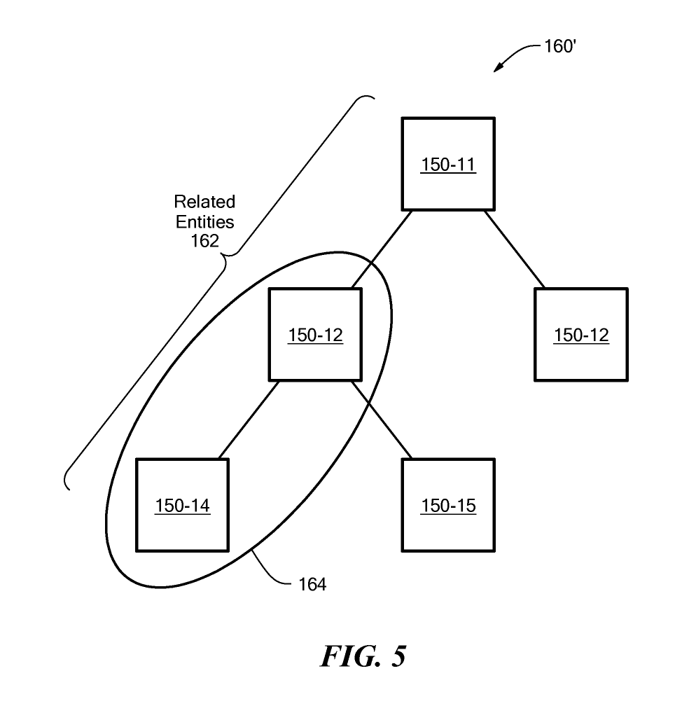

FIG. 5 shows grouping of buckets defined by the hierarchy of FIG. 4. Referring to FIGS. 4 and 5, the hierarchy 160′ defines dependencies between the buckets 150, and includes buckets 150-11 . . . 150-15. The hierarchy 160′ includes branches of related buckets 162, referring to a sequence of buckets 150 along a path of the hierarchy (tree), shown by buckets 150-11, 150-12 and 150-14. A subset or portion of the related buckets is a group 164 of related buckets, meaning that the buckets share a dependency, shown by buckets 150-12 and 150-14.

TABLE I

```
@cached(Buckets.Applications)
def get_applications( ):
  # Get list of applications from database
  . . .
@invalidated(Buckets.Applications)
def update_application(updated_app):
  # Update an application in the database
  . . .
```

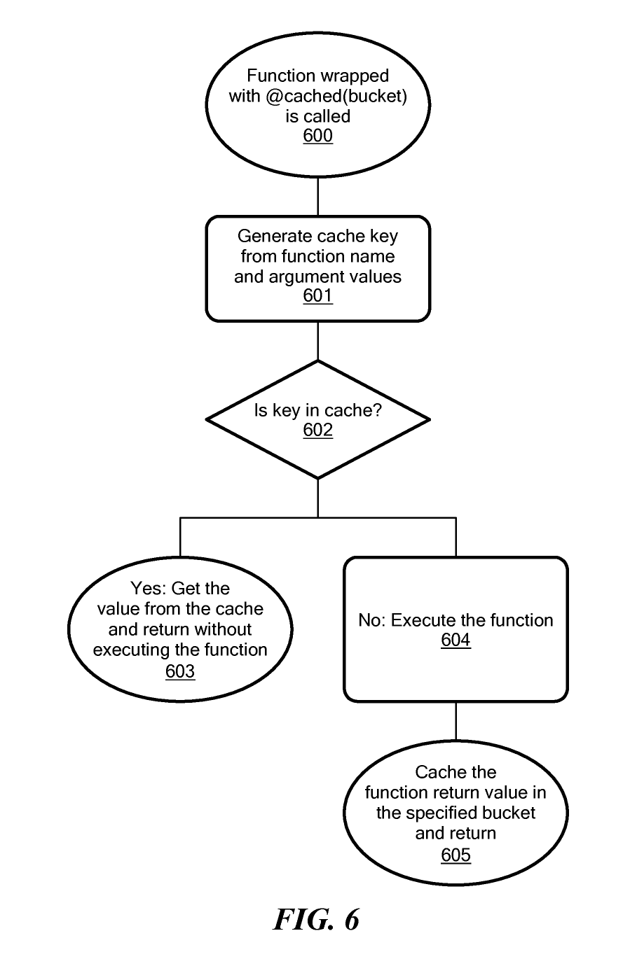

FIG. 6 shows a flowchart of an example configuration of caching in the buckets of FIG. 3. Referring to FIGS. 1, 3 and 6, caching occurs when the web services module 112 invokes the cache server 130 to service a request 104. Referring to FIGS. 1, 3 and 6, The cache server 130 receives a request 104 to invoke a function using a wrapper function, in which the wrapper function associates the function result with a cache entity in the group. At step 600, a function is wrapped with a directive to invoke the label “bucket,” also depicted in TABLE I above. The example of table 1 shows an inline code snippet depicting invocation using the bucket label as a parameter. In this manner, the bucket operations are invoked using a precompiler, in-line recognition by the compiler, or as a textual substitution using the bucket label as an expansion.

The cache server 130 generates the cache key from the function name and argument (parameter) values, as depicted at step 601. The name is therefore used for computing a value for the cached entity based on a received request for a function invocation, in which the function has a name and parameters. The cache server 130 computes a cache key based on the function name and parameters of the received request 104, in which the cache key is indicative of the cached entity 152 and the group 150 (label) of the cached entity.

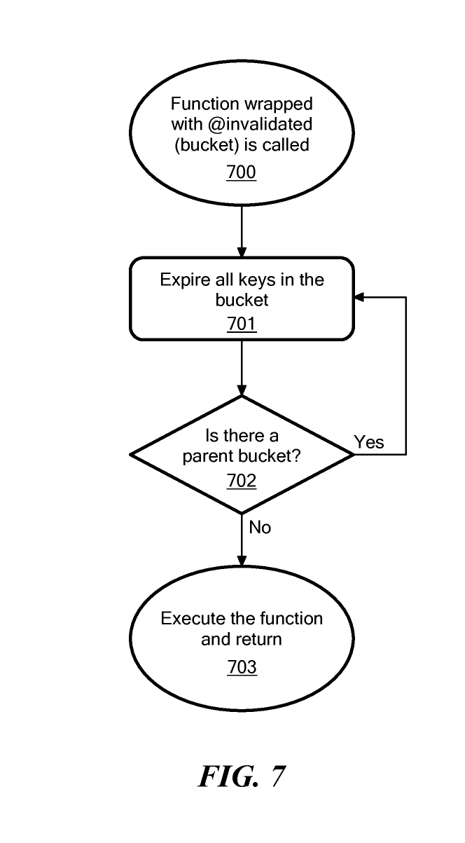

A search is done, at step 602, to determine if the key is in the cache. The cache server 130 will attempt to find the corresponding value in the cache memory 132 (a cache “hit”), or will computer/fetch the sought value and store it in the cache memory 132 for subsequent requests. If the search is successful, the cached value 154 is returned as the function result without executing the function, as depicted at step 603. Alternatively, if the key is not found (a cache “miss”), the function is executed, as disclosed at step 604, and the cache server 130 caches the function return value (result) in the specified bucket 150 indicated by the label and returns, as depicted at step 605. The cache server 130 thus stores the cached entity 152 in a tree 160 based on a hash generated from the parameters and the name of the invoked function, in which the tree 160 defines a hierarchy of the groups. Therefore, the group of cached entities defines a bucket 150, in which the bucket 150 is based on a type of entity to which the function pertains, wherein labeling and invalidating (discussed in FIG. 7 below) refers to the bucket 150. Upon entry in the bucket 150, the cached entity is responsive to a successive function invocation based on a correspondence between the name and the parameters of the invoked function.

FIG. 7 shows a flowchart of cache invalidation of the buckets in FIG. 6. Referring to FIGS. 1, 3, 4, 6 and 7, a function is wrapped with the “invalidate” command including the bucket label, as depicted at step 700. The invalidate command is complementary to a corresponding cache command, as shown above in step 600, but may refer back to multiple cache commands since the bucket may contain multiple entries.

The cache server identifies all keys in the bucket based on the label, and expires all entities in the bucket 150, as depicted at step 701, meaning that all cache values generated with the bucket label are marked as invalid such that successive invocations will compute fresh values for the function. Receiving the invalidate command (via the wrapper function) therefore includes receiving a group (bucket) to which the cached entity belongs, in which the group is indicative of a related set of cached values.

Alternatively, the bucket may be determined from the cache entity, rather than a called out as a parameter. The cache server 130 thus computes the match key from the successive function invocation, in which the match key is computed from the name of the invoked function and the parameters of the invoked function, and mapping to a group corresponding to the related cached entities. The cache server thus receives the type of entity with the request to invalidate the cached entity, invalidating other cached entities in the same bucket 150 as the cached entity parameter.

As discussed with respect to FIG. 4 above, the cache bucket hierarchy identifies other buckets 150 having values that are dependent on the invalidated bucket. A check is performed, at step 702, to identify parent buckets further up the tree 160. Accordingly, the cache server 130 identifies the related cached entities based on a branch of the tree in which the cached entity is stored, and traverses toward the root of the tree 160 to identify the other cached entities in the group. The cache server 130 traverses the tree 160 of cached entities based on the generated hash to identify the corresponding cached entity for invalidation, as shown by the arrow into block 701. The wrapped function is then executed to perform the action which renders the invalidated values obsolete, and control returns, as depicted at step 703.

Particular configurations disclosed herein may take the form of a computing device 110 coupled to the web server 102 via a wireless link, in which the computing device 110 is portable and having an application (app) operable to invoke cached values as disclosed herein. The app therefore defines a computer program product on a non-transitory computer readable storage medium having instructions for performing a method for caching computed results. The corresponding method identifies a set of cached entities as a group, the group related by usage of cached values in the group, and determines that at least one of the cached entities is stale. The cache server 130 in communication with the app then invalidates all of the cached entities in the group corresponding to the determined stale entity.

Those skilled in the art should readily appreciate that the programs and methods defined herein are deliverable to a user processing and rendering device in many forms, including but not limited to a) information permanently stored on non-writeable storage media such as ROM devices, b) information alterably stored on writeable non-transitory storage media such as floppy disks, magnetic tapes, CDs, RAM devices, and other magnetic and optical media, or c) information conveyed to a computer through communication media, as in an electronic network such as the Internet or telephone modem lines. The operations and methods may be implemented in a software executable object or as a set of encoded instructions for execution by a processor responsive to the instructions. Alternatively, the operations and methods disclosed herein may be embodied in whole or in part using hardware components, such as Application Specific Integrated Circuits (ASICs), Field Programmable Gate Arrays (FPGAs), state machines, controllers or other hardware components or devices, or a combination of hardware, software, and firmware components.

While the system and methods defined herein have been particularly shown and described with references to embodiments thereof, it will be understood by those skilled in the art that various changes in form and details may be made therein without departing from the scope of the invention encompassed by the appended claims.

What is claimed is:

1. A method of caching computational results, comprising:
issuing a cache grouping command in conjunction with an invocation of function resulting in a cached function result;
associating the cached function result with a cache group;
issuing an invalidate command indicative of the cache group; and
invalidating all cached function results in the cache group.

2. The method of claim 1 wherein the cache grouping command is a wrapper function encapsulating the invoked function.

3. The method of claim 2 wherein the invalidate comment is a wrapper function encapsulating a function potentially rendering the cached function results in the cache group obsolete.

4. In a managed application environment, a method of managed application environment comprising:
identifying a cached entity, the cached entity generated by execution of a function;
labeling the cached entity with a group, the group indicative of a plurality of related cached entities;
receiving a request to invalidate at least one cached entity in the labeled group; and
invalidating the cached entity and each related cached entity in the labeled group.

5. The method of claim 4 further comprising:
computing a value for the cached entity based on a received request for a function invocation, the function having a name and parameters.

6. The method of claim 5 wherein the cached entity is responsive to a successive function invocation based on a correspondence between the name and the parameters of the invoked function.

7. The method of claim 6 further comprising computing a cache key based on the function name and parameters of the received request, the cache key indicative of the cached entity and the group of the cached entity.

8. The method of claim 4 further comprising identifying complementary functions in the group, the complementary functions for associating cached values with the group and invalidating the associated cached entities storing the cached values in the group.

9. The method of claim 5 further comprising:
computing a match key from the successive function invocation, the match key computed from the name of the invoked function and the parameters of the invoked function; and
mapping the match key to a group corresponding to the related cached entities.

10. The method of claim 5 further comprising storing the cached entity in a tree based on a hash generated from the parameters and the name of the invoked function, the tree defining a hierarchy of the groups.

11. The method of claim 10 further comprising
identifying the related cached entities based on a branch of the tree in which the cached entity is stored; and
traversing toward the root of the tree to identify the other cached entities in the group.

12. The method of claim 11 further comprising traversing the tree of cached entities based on the generated hash to identify the corresponding cached entity for invalidation.

13. The method of claim 4 further comprising:
receiving a request to invalidate the cached entity; and
matching a match key corresponding to the request to a cache key of the cached entity for invalidation.

14. The method of claim 4 wherein receiving the invalidate command further includes receiving a group to which the cached entity belongs, the group indicative of a related set of cached values.

15. The method of claim 4 wherein the group of cached entities defines a bucket, the bucket based on a type of entity to which the function pertains, wherein labeling and invalidating refers to the bucket.

16. The method of claim 15 further comprising
receiving the type of entity with the request to invalidate the cached entity; and
invalidating other cached entities in the same bucket as the cached entity.

17. The method of claim 15 further comprising determining the bucket based on the executed function, the bucket based on a type of entity to which the function pertains.

18. The method of claim 4 further comprising receiving a request to invoke the function using a wrapper function, the wrapper function associating the function result with a cache entity in the group.

19. A computer apparatus for caching function results, comprising:
a cache memory configured to store a cached entity, the cached entity generated by execution of a function;
a wrapper function operable to label the cached entity with a group, the group indicative of a plurality of related cached entities; and
a cache server configured to receive a request to invalidate at least one cached entity in the labeled group, the cache server operable to invalidate the cached entity and each related cached entity in the labeled group.

20. A computer program product on a non-transitory computer readable storage medium having instructions for performing a method for caching computed results, the method comprising:
identifying a set of cached entities as a group, the group related by usage of cached values in the group;
determining that at least one of the cached entities is stale; and
invalidating all of the cached entities in the group corresponding to the determined stale entity.
